(19) United States
(12) Patent Application Publication
(10) Pub. No.: US 2020/0142232 A1
(43) Pub. Date: May 7, 2020

(54) ELECTRICALLY CONTROLLABLE OPTICAL DEVICE, METHOD FOR OPERATION THEREOF, AND SYSTEM INCLUDING AN ELECTRICALLY CONTROLLABLE OPTICAL DEVICE

(71) Applicants: Applied Materials, Inc., Santa Clara, CA (US); Halation Photonics Corporation, Sozhou (CN)

(72) Inventors: Rainer DEMUTH, Bruchköbel (DE); Sun GANG, Beijing (CN); Yu REN, Suzhou (CN); Wenlei LI, Suzhou (CN); Panhua ZHOU, Suzhou (CN); Grant HAY, Burlingame, CA (US); Paul KORFF, Sunnyvale, CA (US); Madhavi KANTETI, Mountain View, CA (US); Michael P. STEWART, San Francisco, CA (US)

(21) Appl. No.: 16/626,964

(22) PCT Filed: Jul. 14, 2017
(86) PCT No.: PCT/CN2017/092889

§ 371 Date: Dec. 27, 2019

(51) Int. Cl. G02F 1/133; G02F 1/137; G03B 9/08; G03B 11/04; G02F 1/1333

(52) U.S. Cl. CPC G02F 1/13306; G02F 1/13781; G02F 2202/16; G03B 11/041; G02F 1/133382; G03B 9/08

(57) ABSTRACT

The present disclosure provides an electrically controllable optical device and a method for operating the same. The electrically controllable optical device comprises a multi-stable liquid crystal layer and a controller, wherein the electrically controllable optical device is switchable between a transparent state and a non-transparent state. The method for operating the electrically controllable optical device comprises applying a voltage to the multi-stable liquid crystal layer, controlling at least one of the amplitude, frequency and number of pulses of the voltage to switch the electrically controllable optical device between a transparent state and a non-transparent state, and removing the voltage.

### BACKGROUND

### Field

Embodiments of the present disclosure relate to an electrically controllable optical device, a method for operation of an electrically controllable optical device, and a system including an electrically controllable optical device. Embodiments of the present disclosure particularly relate to methods and apparatus used in privacy applications, more particularly in privacy shutters for cameras.

### Description of the Related Art

Privacy and security are becoming increasingly relevant topics in the design of electronic devices. In-built cameras are ubiquitous in many electronic devices, including mobile phones, tablets and laptop computers, introducing privacy and security issues relating to unauthorized access to cameras.

Various devices and methods exist for protecting users against unauthorized access to cameras in electronic devices.

One such device is a mechanical shutter that includes an opaque shutter component which slides in front of a camera unit, such that the camera is covered when not in use. A mechanical shutter has the advantage of low cost, isolation from external control, stability without applied power, and 100% transmissivity when open. However, a mechanical shutter has significant thickness and width, which may be unsuitable for integration into increasingly compact electronic devices with narrow screen bezels and thin housings. Further, mechanical shutters include small moving parts which are prone to breakage.

Another such device is a shutter including polymer dispersed liquid crystals (PDLC). A PDLC shutter includes a layer of PDLC material which is switched between a light-transmission state and a light-scattering state through the application of a voltage. A PDLC shutter is solid-state and electrically controllable; however in order for a PDLC material to remain in a light-scattering state, a continuous supply of voltage is maintained. Further, PDLC material when in a light-transmission state has a transmissivity of 85% or less, which reduces camera performance. In addition, the haze level of PDLC material is normally as high as 5% or more when in a transparent state, which causes a blurring effect during camera recording.

Therefore, there exists a need for apparatus and methods for improving privacy and security from unauthorized access to cameras in electronic devices. The present disclosure particularly aims to improve privacy and security such that the apparatus or method may be stable without applied voltage.

### SUMMARY

In light of the above, an electrically controllable optical device, a method for operation of the electrically controllable optical device, and a use of the electrically controllable optical device are provided. Further aspects, benefits, and features of the present disclosure are apparent from the claims, the description, and the accompanying drawings.

According to an aspect of the present disclosure, an electrically controllable optical device is provided. The electrically controllable optical device includes a multi-stable liquid crystal layer and a controller, wherein the electrically controllable optical device is switchable between a transparent state and a non-transparent state.

According to a further aspect of the present disclosure, a method for operating the electrically controllable optical device is provided. The method includes applying a voltage to the multi-stable liquid crystal layer, controlling at least one of the amplitude, frequency and duration of the voltage to switch the electrically controllable optical device between a transparent state and a non-transparent state, and removing the voltage.

According to a further aspect of the present disclosure, a use of an electrically controllable optical device is provided. The use includes using an electrically controllable optical device for a privacy shutter optically positioned in front of at least one camera unit.

According to a further aspect of the present disclosure, a system is provided. The system includes an electronic device including at least one camera unit, and an electrically controllable optical device wherein the electrically controllable optical device is positioned between a user and the at least one camera unit.

Embodiments are also directed at apparatuses for carrying out the disclosed method and include apparatus parts for performing each described method aspect. These method aspects may be performed by way of hardware components, a computer programmed by appropriate software, by any combination of the two or in any other manner. Furthermore, embodiments according to the disclosure are also directed at methods for operating the described apparatus. The methods for operating the described apparatus include method aspects for carrying out every function of the apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic view of an electrically controllable optical device according to embodiments described herein;

FIG. 2 shows a schematic view of a shutter device of an electrically controllable optical device according to embodiments described herein;

FIG. 3 shows a schematic view of a controller for an electrically controllable optical device according to embodiments described herein;

FIG. 4 shows a schematic view of a shutter device of an electrically controllable optical device according to further embodiments described herein;

FIG. 5 shows a schematic view of a shutter device of an electrically controllable optical device according to further embodiments described herein;

FIG. 6 shows a schematic view of a system including an electronic device including a camera, and an electrically controllable optical device according to embodiments described herein.

FIG. 7 shows a flow chart of a method for operating an electrically controllable optical device according to embodiments described herein;

### DETAILED DESCRIPTION

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

It is becoming increasingly relevant to protect from unauthorized access to electronic devices. Particularly, it is desirable that data captured by cameras contained in electronic devices such as mobile telephones, laptop computers and tablets is protected from unauthorized access. The present disclosure uses a multi-stable liquid crystal material to allow or restrict the capture of images by cameras in an electronic device. A multi-stable liquid crystal material can be switched between a transparent state and a non-transparent state by the application of a voltage at a specific amplitude, frequency and duration. Due to the multi-stable properties of the multi-stable liquid crystal material, voltage is only applied in order to switch the state of transparency. The maintaining of a state of transparency (either a transparent state or a non-transparent state) can be achieved without an applied voltage being present. When in a transparent state, the haze level is very low, typically lower than 2%, which minimizes the blurring effect during camera recording.

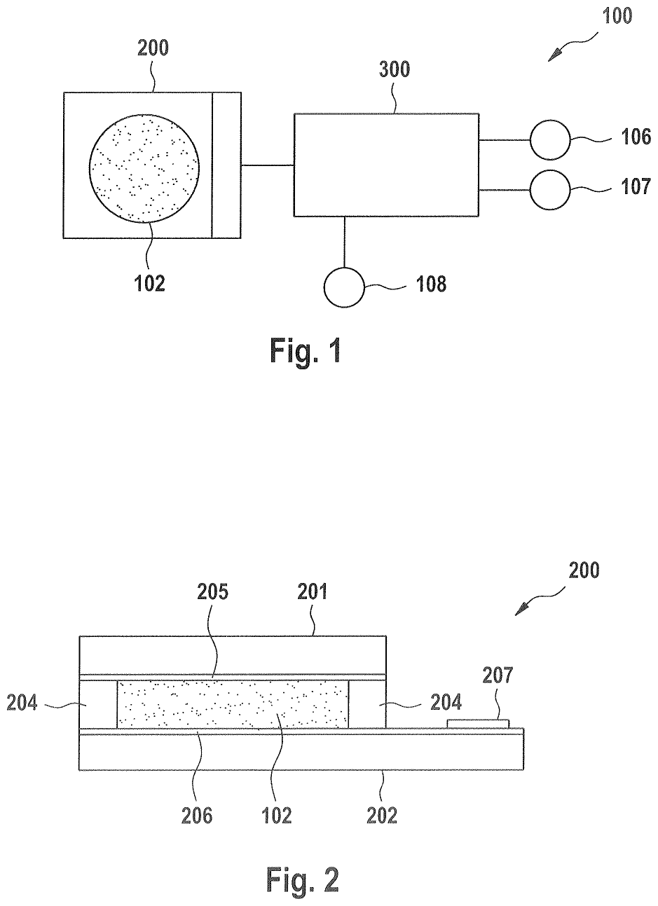

FIG. 1 shows a schematic view of an electrically controllable optical device 100 according to embodiments described herein.

The electrically controllable optical device 100 includes a multi-stable liquid crystal layer 102 and a controller 300. The multi-stable liquid crystal layer 102 is switchable between a transparent state and a non-transparent state.

Hereinafter, the term “transparent state” is to be understood as a state in which sufficient light transmission occurs in order to distinguish an image. When in a “transparent state”, multi-stable liquid crystal layer 102 may have a light transmissivity of, for example, 70% to 100%. The term “non-transparent state” is to be understood as a state in which sufficient light is blocked, scattered or refracted in order to render an image indistinguishable. When in a “non-transparent state”, multi-stable liquid crystal layer 102 may have a light transmissivity of, for example, 0% to 40%.

The multi-stable liquid crystal layer 102 includes a mixture of smectic liquid crystals, polymer materials and dopants. When an electrical power is applied to the multi-stable liquid crystal layer 102, the smectic liquid crystal molecules can exhibit different molecule alignments by controlling the amplitude, frequency and duration of the applied electrical power.

In the multi-stable liquid crystal layer 102, the smectic liquid crystal molecules are allowed to exhibit different molecule alignments by controlling the amplitude, frequency and duration of an electrical voltage applied thereto. When the smectic liquid crystal molecules are all regularly aligned, the refractive index of the smectic liquid crystals is very similar to the refractive index of the glass or polymer substrates. Hence, the electrically controllable optical device is in a transparent state. When the smectic liquid crystal molecules are randomly aligned as focal conic alignment, light is strongly scattered within the multi-stable liquid crystal layer 102 due to the birefringence of the smectic molecules.

Depending on the alignment of the smectic liquid crystal molecules, the multi-stable liquid crystal layer 102 can exhibit a range of states between almost total light transmission and almost total light scattering. The multi-stable liquid crystal layer 102 can be electrically switched between a transparent state and a non-transparent state.

The multi-stable liquid crystal layer 102 exhibits a multi-stable property. The material can maintain the same optical transmittance state even when voltage is removed. Voltage is only applied to the multi-stable liquid crystal layer 102 in order to change the alignment states of the liquid crystal molecules.

The smectic liquid crystals included in the multi-stable liquid crystal layer 102 include Smectic-A liquid crystal organic compound. The smectic liquid crystals may include a siloxane compound according to at least one of the following formulae:

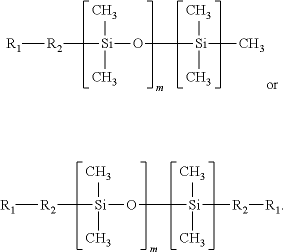

Wherein R1 refers to 4-alkenoxy-4′ cyanobiphenyl component, and R2 refers to an alkyl chain. The value of m may be in the range of 1 to 4, and the number of carbons in R2 may be in the range of 3 to 15.

The polymer material included in the multi-stable liquid crystal layer 102 is formed from monomers by thermal curing or ultraviolet curing. The monomers may include at least one of, for example, Noland optical adhesive 65 (NOA65), Norland optical adhesive 63 (NOA63), Norland optical adhesive 68 (NOA68) and Norland optical adhesive 7× (NOA7×). Such materials are products manufactured by Norland Company. The ratio by weight of monomers to the smectic liquid crystals may be less than 30:100, particularly less than 15:100. A higher ratio by weight of monomers to smectic liquid crystals reduces the light scattering effect when the multi-stable liquid crystal layer 102 is in a non-transparent state, however the light transmittance when the multi-stable liquid crystal layer 102 is in a transparent state is increased.

The dopants included in multi-stable liquid crystal layer 102 are conductive compounds added to improve the conductivity of multi-stable liquid crystal layer 102. Application of voltage to the multi-stable liquid crystal layer 102 causes dopants to migrate through the layer, causing the smectic liquid crystal molecules to change alignment. Dopants may include at least one of cetyl trimethyl ammonium bromide (CTAB) or hexadecyl trimethyl ammonium perchlorate (HMAP). The ratio by weight of the dopants to the smectic liquid crystals may be less than 1:100, particularly less than 1:1000. A higher ratio by weight of dopants to smectic liquid crystals tends to increase the voltage at which the dopants migrate.

Multi-stable liquid crystal layer 102 may be switched from a transparent state to a non-transparent state by the application of voltage. The applied voltage may be applied at an amplitude and/or a frequency, and for a number of pulses.

The amplitude of the applied voltage may be dependent on the thickness and the temperature of the multi-stable liquid crystal layer 102. When switching the multi-stable liquid crystal layer 102 to a non-transparent state or a transparent state, the amplitude of the applied voltage may be in a range of 20 V to 250 V. Particularly, the voltage may be in a range of 50 V to 100 V, more particularly in the range of 60 V to 85 V. The applied voltage may be an AC voltage.

Applying voltage at a first frequency may cause the smectic liquid crystal molecules and dopant molecules to be affected such that the smectic liquid crystal molecules are randomly aligned. A random alignment of smectic liquid crystal molecules causes the multi-stable liquid crystal layer 102 to be in a non-transparent state. When switching the multi-stable liquid crystal layer 102 to a non-transparent state, the frequency of the applied voltage may be, for example, less than 500 Hz, particularly in the range of 10 Hz to 200 Hz.

Applying voltage at a second frequency may cause the smectic liquid crystal molecules and dopant molecules to be affected such that the long axes of the smectic liquid crystal molecules are regularly aligned in a viewing direction, perpendicular to the multi-stable liquid crystal layer 102. A regular alignment of smectic liquid crystal molecules in the viewing direction causes the multi-stable liquid crystal layer 102 to be in a transparent state. When switching the multi-stable liquid crystal layer 102 to a transparent state, the frequency of the applied voltage may be, for example, more than 500 Hz, particularly in the range of 1 kHz to 5 kHz.

According to some embodiments, which can be combined with other embodiments described herein, the multi-stable liquid crystal layer 102 may have a thickness in a range of 2 μm to 25 μm. If the thickness of the multi-stable liquid crystal layer 102 is less than 5 μm, the scattering effect is reduced and a sufficiently non-transparent state may be difficult to achieve. Conversely, if the thickness of the multi-stable liquid crystal layer 102 is more than 20 μm, the applied voltage at which the multi-stable liquid crystal layer 102 is switched between a transparent state and a non-transparent state (or vice versa) is increased, and light transmission when the multi-stable liquid crystal layer 102 is in a transparent state is reduced.

According to some embodiments, which can be combined with other embodiments described herein, the multi-stable liquid crystal layer 102 may have an area of up to 2000 mm². Particularly, the multi-stable liquid crystal layer 102 may have an area in the range of 4 mm² to 2000 mm², more particularly in the range of 12 mm² to 100 mm². The multi-stable liquid crystal layer 102 may be of any shape, particularly a circular, oval, rectangular or square shape.

According to some embodiments, which can be combined with other embodiments described herein, electrically controllable optical device 100 may further include a physical user-operable control 106. User-operable control 106 allows for the user to switch the electrically controllable optical device 100 from a transparent state to a non-transparent state, and vice-versa.

User-operable control 106 may include any one of a toggle switch, a push button and a capacitive touch sensor. User-operable control 106 may be provided separate to and electrically coupled with controller unit 300. Alternatively, user-operable control 106 may be integrated into controller unit 300.

User-operable control 106 allows for operation of the electrically controllable optical device 100 to be operationally isolated from any other electrical system, such that the electrically controllable optical device is physically operable by a user.

Hereinafter, the term “operatively isolated” is to be understood as not being permitted to operate the electrically controllable optical device 100 by an external system or device other than physical interaction with a user. “Operating” may include switching the electrically controllable optical device 100 between a transparent state and a non-transparent state, and vice-versa, as well as switching the electrically controllable optical device 100 to a partially transparent state. “Operative isolation” may include isolation from optical operation, electrical operation or physical operation by an external system or device other than physical interaction with a user.

According to some embodiments, which can be combined with other embodiments described herein, electrically controllable optical device 100 may further include status indicator 107. Status indicator 107 serves to indicate the current state of electrically controllable optical device 100 to a user. Status indicator 107 may include an electrical indicator, for example a light-emitting diode (LED), and may be integrated into any one of shutter device 200 or controller unit 300.

Status indicator 107 may include an indicating device which may be covered, obscured or hidden by the electrically controllable optical device 100 when the electrically-controlled optical device 100 is switched to a non-transparent state. For example, a colored indicator layer may be provided on rear substrate 201 such that the colored indicator layer may be visible when the electrically-controlled optical device 100 is switched to a transparent state, and may be hidden when the electrically-controlled optical device 100 is switched to a non-transparent state.

According to some embodiments, which can be combined with other embodiments described herein, electrically controllable optical device 100 may further include a temperature sensor 108. Temperature sensor 108 may be mounted in close proximity to shutter unit 200 and multi-stable liquid crystal layer 102. Temperature sensor 108 measures the temperature of the multi-stable liquid crystal layer 102, and/or the region close to multi-stable liquid crystal layer 102. Temperature sensor 108 may be electrically coupled to controller unit 300 to provide a temperature measurement signal to controller unit 300. Temperature sensor 108 may be integrated into controller unit 300, or may be mounted in a location remote to controller unit 300.

Since the amplitude, frequency and/or number of pulses of the voltage applied to multi-stable liquid crystal layer 102 for switching from a transparent state to a non-transparent state (and vice-versa) is dependent on the temperature, the temperature measurement signal provided to controller unit 300 allows the amplitude, frequency and/or number of pulses to be controlled according to the current temperature of multi-stable liquid crystal layer 102.

FIG. 2 shows a schematic view of a shutter device 200 according to further embodiments described herein.

Shutter device 200 includes a rear substrate 201 and a front substrate 202, wherein the multi-stable liquid crystal layer 102 may be provided between the rear substrate 201 and the front substrate 202. At least one of the rear substrate 201 and the front substrate 202 may include a ceramic material or a polymer material. For example, the rear substrate 201 and front substrate 202 may include glass. Ceramic materials provide increased stability and good mechanical properties, while polymer materials provide high durability and ease of manufacture. Both ceramic and polymer materials exhibit good optical performance.

According to some embodiments, which can be combined with other embodiments described herein, shutter device 200 further includes at least a transparent conductive layer 205, 206. Transparent conductive layer 205, 206 may be deposited on at least one of the rear substrate 201 and the front substrate 202 such that the transparent conductive layer 205, 206 may be in contact with the multi-stable liquid crystal layer 102.

Transparent conductive layer 205, 206 may be formed from a transparent conductive material, for example, indium-tin oxide (ITO). Transparent conductive layer 205, 206 may be deposited by a physical vapor deposition process, particularly a sputter deposition process.

Transparent conductive layer 205, 206 may be formed such that a patterned electrode is provided. For example, a patterned electrode of striped transparent conductive material or a grid of transparent conductive material may be provided. In the case where at least two transparent conductive layers 205, 206 are provided, the pattern of a first transparent conductive layer 205 may be different than the pattern of a second transparent conductive layer 206. The first and second patterned transparent conductive layers 205, 206 may be formed in the same shape or a similar shape as multi-stable liquid crystal layer 102.

Shutter device 200 may further include with electrode pads 207. Electrode pads 207 allow for the attachment of an electrical connection between the shutter device 200 and a controller unit 300. Electrode pads 207 may be included in at least one of transparent conductive layer 205, 206. Alternatively, electrode pads 207 may include a layer deposited upon at least one of transparent conductive layer 205, 206, and may include a conductive material such as a ceramic (indium-tin oxide) or a metal (tin, copper, silver, gold, or alloys thereof).

Shutter device 200 may further include seal 204. Seal 204 may be provided between rear substrate 201 and front substrate 202 such that seal 204 surrounds multi-stable liquid crystal layer 102. Seal 204 may be formed to provide a filling aperture for introducing multi-stable liquid crystal layer 102 into the space formed between rear substrate 201, front substrate 202 and seal 204.

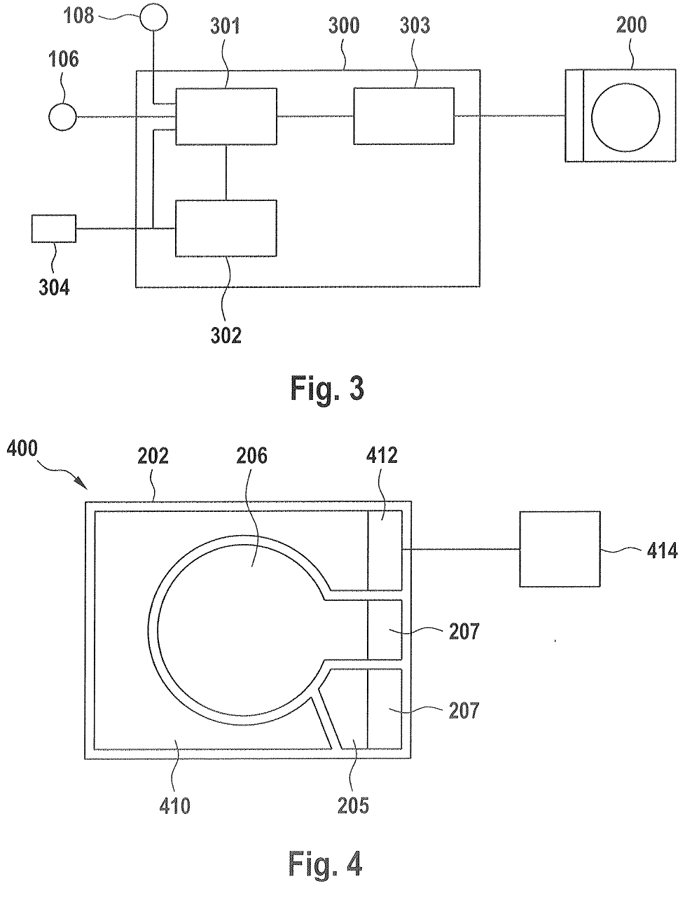

FIG. 3 shows a schematic view of controller unit 300 according to embodiments described herein.

According to some embodiments, which can be combined with other embodiments described herein, controller unit 300 may include a microcontroller unit 301, a voltage converter element 302 and a switching element 303. Controller unit 300 may further include connections to at least one of shutter device 200, user-operable control 106, temperature sensor 108 or power source 304. Alternatively, controller unit 300 may include at least one of shutter device 200, user-operable control 106 and temperature sensor 108.

Microcontroller unit 301 may include a CPU, a memory and input and output device in communication with components included in controller unit 300 and/or with components external to controller unit 300. The input and output device may include at least one of a digital-to-analog converter (DAC), an analog-to-digital converter (ADC), and a pulse width modulator (PWM).

In order for multi-stable liquid crystal layer 102 to be switched from a transparent state to a non-transparent state, the applied voltage may be higher than the typical voltages supplied by an electronic device. Voltage converter element 302 includes an electrical circuit for converting input voltage received at power source 304 to an output voltage. For example, voltage converter element 302 may include a step-up converter. The input voltage supplied to voltage converter 302 may be in the range of, for example, 2V to 24V. The output voltage supplied by voltage converter element 302 may be in the range of, for example, 20V to 250V. Voltage converter element 302 may be electrically coupled to microcontroller unit 301, switching element 303 and/or power source 304.

In order for multi-stable liquid crystal layer 102 to be switched from a transparent state to a non-transparent state, voltage may be applied at a certain frequency. Switching element 303 includes an electrical switching device for switching the output voltage from voltage converter element 302 for application of voltage to multi-stable liquid crystal layer 102. Switching element 303 may include at least one of a bipolar junction transistor (BJT) and a field effect transistor (FET). Switching element 303 may be electrically coupled to microcontroller unit 301, voltage converter element 303 and/or shutter device 200. Microcontroller unit 301 may be capable of controlling switching element 303 using, for example, pulse width modulation (PWM) in order to control at least one of the amplitude, frequency and duration of the voltage applied to multi-stable liquid crystal layer 102. When switching the multi-stable liquid crystal layer 102 to a non-transparent state, the frequency of the voltage generated by switching element 303 may be, for example, less than 500 Hz, particularly in the range of 10 Hz to 200 Hz. When switching the multi-stable liquid crystal layer to a transparent state, the frequency of the voltage generated by switching element 303 may be, for example, more than 500 Hz, particularly in the range of 1 kHz to 5 kHz.

FIG. 4 shows a schematic view of a shutter device 400 according to further embodiments described herein.

According to some embodiments, which may be combined with other embodiments described herein, shutter device 400 may include electrostatic discharge (ESD) layer 410. In order to protect shutter device 400 from possible accumulation of static charge, ESD layer 410 may direct accumulated static charge to an electrode 412, which may be attached to an earth 414. Earth 414 may be an earth point located on a conductive area of a chassis or frame.

ESD layer 410 may be deposited on at least a surface of at least one of rear substrate 201 and front substrate 202. ESD layer 410 may be formed in an etching process where one or more layers of deposited material is etched to form both transparent conductive layer 205, 206 and ESD layer 410. ESD layer 410 may be deposited by a physical vapor deposition process, particularly a sputter deposition process, and may include a conductive material such as a ceramic (indium-tin oxide) or a metal (tin, copper, silver, gold, or alloys thereof). ESD layer 410 may be formed to surround the same shape or a similar shape as multi-stable liquid crystal layer 102.

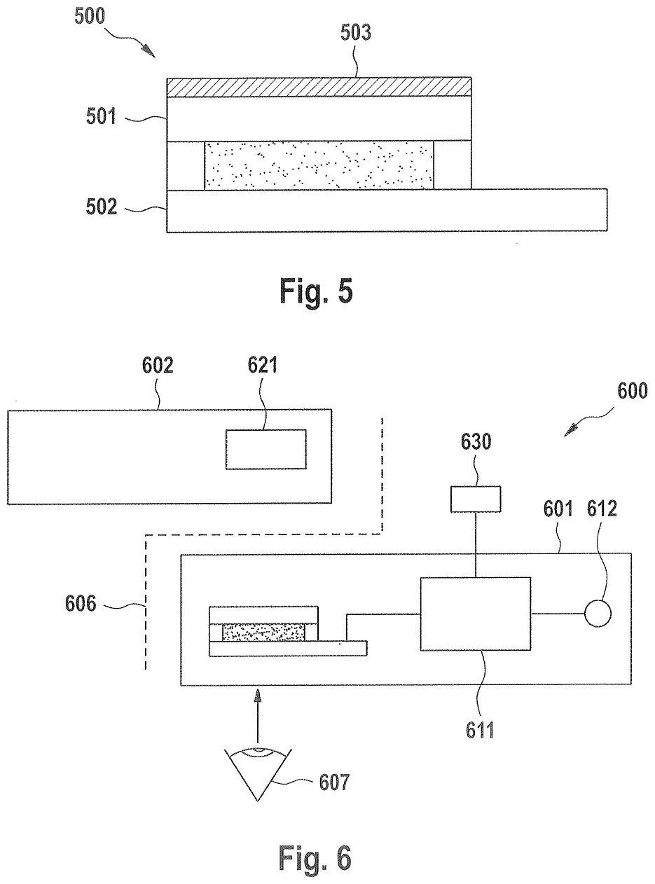

FIG. 5 shows a schematic view of a shutter device 500 according to further embodiments described herein.

According to some embodiments, which can be combined with other embodiments described herein, shutter device 500 further includes at least an anti-reflective layer 503. The addition of anti-reflective layer 503 improves the optical performance of shutter device 500, particularly by improving transmissivity. A shutter device 500 including rear/front substrates 501, 502 including glass and anti-reflective coating 503 can result in a light transmissivity of 92% or more.

Anti-reflective layer 503 may be provided on at least one of the rear substrate 501 and the front substrate 502. Anti-reflective layer 503 may particularly be provided on the outer surface of rear substrate 501. Anti-reflective layer 503 may be deposited by a physical vapor deposition process, particularly a sputter deposition process, and may include a ceramic material. For example, anti-reflective layer 503 may include at least one of silicon dioxide, silicon nitride, titanium oxide or niobium oxide. Anti-reflective layer 503 may include one layer of material, or may include two or more layers of material.

FIG. 6 shows a schematic view of a system 600 including an electronic device 602 including a camera 621 and an electrically controllable optical device 601 according to embodiments described herein.

In system 600, electrically controllable optical device 601 is provided between a user 607 and a camera 621. Camera 621 may be operatively coupled with electronic device 602. Electronic device 602 may be, for example, a computer, a mobile telephone, a tablet or a game console which records image data from camera 621 for various tasks such as, for example, video telephony, video recording or surveillance. Providing system 600 with electrically controllable optical device 601 positioned between user 607 and camera 621 allows the user to block, cover or obscure camera 621 when not in use, in order to improve privacy and security.

According to some embodiments, which may be combined with other embodiments described herein, in system 600, electrically controllable optical device 601 may be operatively isolated 606 from electronic device 602.

Due to operative isolation 606 of electrically controllable optical device 601 and electronic device 602, any form of operation of electrically controllable optical device 601 may not be permitted by the electronic device 602. Having electrically controllable optical device 601 operationally isolated from electronic device 602 prevents unauthorized control of electrically controllable optical device 601 and prevents unauthorized recording or viewing of the user, or the environment in which the system 600 is situated, improving privacy and security.

According to some embodiments, which may be combined with other embodiments described herein, electrically controllable optical device 601 may be electrically coupled to power source 630. Power source 630 may be a dedicated power source for the electrically controllable optical device 601, or may alternatively be a shared power source which supplies power to, for example, electrically controllable optical device 601 and electronic device 602.

According to some embodiments, which may be combined with other embodiments described herein, electrically controllable optical device 601 may only be physically operable by the user 607. Since the electrically controllable optical device 601 may be operatively isolated 606 from electronic device 602, the only permissible form of input from a user may be through physical interaction with user-operable control 612.

Due to the multi-stable properties of the liquid crystal layer of electrically controllable optical device 601, the electrically controllable optical device 601 may only be switched when voltage at a specific amplitude, frequency and duration is applied by the controller unit 611. For example, removing, applying or controlling the input voltage from power source 630 will not cause electrically controllable optical device 601 to switch from a current state of transparency to a different state of transparency.

According to some embodiments, which may be combined with other embodiments described herein, the components of system 600 including electrically controllable optical device 601 and electronic device 602 may be provided in a common housing. Alternatively, electrically controllable optical device 601 may be provided in a separate housing to that of a first electronic device 602 such that electrically controllable optical device 601 may be removed and installed on a second electronic device 602.

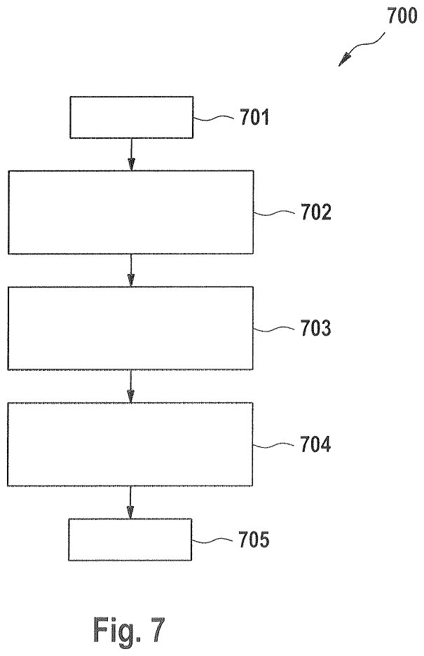

FIG. 7 shows a flowchart of a method 700 for operating an electrically controllable optical device according to embodiments described herein. The method 700 can be implemented using the apparatuses and systems according to the present disclosure.

The method 700, beginning at start 701, includes applying a voltage to a multi-stable liquid crystal layer 702, controlling at least one of the amplitude, frequency and duration of the applied voltage 703, and removing the voltage 704. Method 700 concludes at end 705.

According to some embodiments, which can be combined with other embodiments described herein, controlling the amplitude of the applied voltage 703 may include controlling the amplitude in a range of 20 V to 250 V.

According to some embodiments, which can be combined with other embodiments described herein, controlling the frequency of the applied voltage 703 when switching the multi-stable liquid crystal layer to a transparent state may include controlling the frequency in a range of 100 Hz to 4 kHz, particularly in a range of 200 Hz to 2 kHz.

According to some embodiments, which can be combined with other embodiments described herein, controlling the frequency of the applied voltage 703 when switching the multi-stable liquid crystal layer to a non-transparent state may include controlling the frequency in a range of 1 Hz to 2 kHz, particularly in a range of 1 kHz to 10 kHz, more particularly in a range of 10 Hz to 1 kHz.

Controlling the number of pulses of the applied voltage 703 is performed in order to allow time for the multi-stable liquid crystal layer to switch from a transparent state to a non-transparent state, or vice-versa. The number of pulses of the applied voltage may be controlled to a duration of up to two seconds. When the multi-stable liquid crystal layer is switched from a non-transparent state to a transparent state, the number of pulses of the applied voltage may particularly be controlled to up to 1000 pulses. When the multi-stable liquid crystal layer is switched from a transparent state to a non-transparent state, the number of pulses of the applied voltage may particularly be controlled to up to 1000 pulses.

The amplitude, frequency and/or number of pulses of the applied voltage for switching multi-stable liquid crystal layer are dependent on the temperature of the multi-stable liquid crystal layer. Controlling at least one of the amplitude, frequency and number of pulses of the applied voltage 703 may further include adapting at least one of the amplitude, frequency and number of pulses of applied voltage according to the measured temperature of the multi-stable liquid crystal layer, or according to the measured temperature in the region around the multi-stable liquid crystal layer.

Removing the voltage 704 causes the electrically controllable optical device to remain in a stable state of transparency. Due to the multi-stable property of the multi-stable liquid crystal layer, the state of transparency is maintained without the continued application of voltage.

While the foregoing is directed to embodiments of the disclosure, other and further embodiments of the disclosure may be devised without departing from the basic scope thereof, and the scope thereof is determined by the claims that follow.

1. An electrically controllable optical device, comprising:
a multi-stable liquid crystal layer; and
a controller unit,
wherein the electrically controllable optical device is switchable between a transparent state and a non-transparent state.

2. The electrically controllable optical device of claim 1, further comprising a front substrate, a rear substrate and at least a transparent conductive layer, wherein the multi-stable liquid crystal layer is provided between the front substrate and the rear substrate, and wherein at least one of the front substrate and the rear substrate comprise one of a ceramic material and a polymer material.

3. The electrically controllable optical device of claim 1, further comprising a temperature sensor.

4. The electrically controllable optical device of claim 1, further comprising at least an anti-reflective layer.

5. The electrically controllable optical device of claim 1, further comprising a status indicator.

6. The electrically controllable optical device of claim 1, wherein the multi-stable liquid crystal layer has a thickness from 2 μm to 25 μm.

7. The electrically controllable optical device of claim 1, wherein the multi-stable liquid crystal layer has an area of up to 2000 mm2.

8. The electrically controllable optical device of claim 1, wherein the controller unit comprises:
a microcontroller unit;
a voltage converter element; and
a switching element,
wherein the switching element is electrically controllable by the microcontroller unit.

9. The electrically controllable optical device of claim 1, further comprising a physical user-operable control.

10. A method for operating an electrically controllable optical device comprising a multi-stable liquid crystal layer and a controller unit, wherein the electrically controllable optical device is switchable between a transparent state and a non-transparent state, the method comprising:
applying a voltage to the multi-stable liquid crystal layer;
controlling at least one of the amplitude, frequency and number of pulses of the voltage to switch the electrically controllable optical device between a transparent state and a non-transparent state; and
removing the voltage.

11. The method of claim 10, wherein the amplitude of the voltage is between 0 V and 250 V, particularly between 10 V and 200 V, more particularly between 20 V and 100 V.

12. The method of claim 10, wherein the frequency of the voltage for switching the electrically controllable optical device to a transparent state is in a range of 100 Hz to 4 kHz, particularly in a range of 200 Hz to 2 kHz, and the frequency of the voltage for switching the electrically-controllable optical medium to a non-transparent state is in a range of 1 Hz to 2 kHz, particularly in a range of 10 Hz to 1 kHz.

13. Use of an electrically controllable optical device comprising a multi-stable liquid crystal layer and a controller unit, wherein the electrically controllable optical device is switchable between a transparent state and a non-transparent state, wherein the electrically controllable optical device is a privacy shutter optically positioned in front of at least one camera unit.

14. A system comprising:
an electronic device comprising at least one camera unit; and
an electrically controllable optical device comprising a multi-stable liquid crystal layer and a controller unit, wherein the electrically controllable optical device is switchable between a transparent state and a non-transparent state,
wherein the electrically controllable optical device is positioned between a user and the at least one camera unit.

15. The system of claim 14, wherein the electrically controllable optical device is operationally isolated from the electronic device and is physically operable by the user.

16. The electrically controllable optical device of claim 2, further comprising at least an anti-reflective layer.

17. The electrically controllable optical device of claim 2, wherein the controller unit comprises:
a microcontroller unit;
a voltage converter element; and
a switching element,
wherein the switching element is electrically controllable by the microcontroller unit.

18. The electrically controllable optical device of claim 3, wherein the controller unit comprises:
a microcontroller unit;
a voltage converter element; and
a switching element,
wherein the switching element is electrically controllable by the microcontroller unit.

19. The electrically controllable optical device of claim 8, further comprising a physical user-operable control.

20. The method of claim 11, wherein the frequency of the voltage for switching the electrically controllable optical device to a transparent state is in a range of 100 Hz to 4 kHz, particularly in a range of 200 Hz to 2 kHz, and the frequency of the voltage for switching the electrically-controllable optical medium to a non-transparent state is in a range of 1 Hz to 2 kHz, particularly in a range of 10 Hz to 1 kHz.
